(19) United States
(12) Patent Application Publication
(10) Pub. No.: US 2026/0039099 A1
(43) Pub. Date: Feb. 5, 2026

(54) CABLE ASSEMBLY

(71) Applicant: HUBER+SUHNER AG, Herisau (CH)

(72) Inventors: Thomas CANTZ, Stäfa (CH); Roger Loser, Uster (CH); Andreas Hediger, Jona (CH); Reto Casanova, Pfäffison (CH); Grzegorz Szweda, Elblag (PL); Kirill Sokolov, Brugg (CH)

(73) Assignee: HUBER+SUHNER AG, Herisau (CH)

(21) Appl. No.: 19/353,834

(22) Filed: Oct. 9, 2025

Related U.S. Application Data
(63) Continuation-in-part of application No. PCT/EP2024/058047, filed on Mar. 26, 2024.

(30) Foreign Application Priority Data
Apr. 11, 2023 (DE) 102023109084.4

(51) Int. Cl. H02G 3/04; B60R 16/02; H02G 15/02

(52) U.S. Cl. CPC H02G 3/0406; B60R 16/0215; H02G 15/02

(57) ABSTRACT

A cable assembly (1) comprises a cable conduit (2) which forms a interstitial space (3) passage along a longitudinal direction. Inside the interstitial space (3), a plurality of electrical conductors (4) extend along the longitudinal direction. The interstitial space (3) is suitable for conducting a coolant. The cable assembly (1) further comprises a first terminal element (5) to which the electrical conductors (4) are individually electrically interconnected at a first end (6) of the cable hose (2).

### CROSS-REFERENCE TO RELATED APPLICATIONS

This application is a continuation-in-part of PCT Patent Application No. PCT/EP2024/058047, filed on 26 Mar. 2024, which claims the benefit of German Patent Application No. DE 102023109084.4, filed on 11 Apr. 2023. The co-pending parent patent application(s) is hereby incorporated by reference herein in its entirety and is made a part hereof, including but not limited to those portions which specifically appear hereinafter.

### FIELD OF THE DISCLOSURE

The present invention relates to a cable assembly.

The proliferation of electric vehicles has increased significantly in recent years. The everyday operation of such vehicles requires the transmission of high currents, in particular for charging the drive batteries. During a fast charging process, currents of several hundred amperes are not uncommon. Such high currents push conventional cable connections to their limits, in particular due to the high heat generation in normal copper conductors due to their ohmic resistance.

To address this issue, JP 2012238532 A proposes a cable unit for fast charging an electric vehicle that can handle high currents. The cable unit comprises a corrugated tube that is sealed at both ends. Several electrical conductors run inside the corrugated tube and are cooled by a coolant that is fed through the corrugated tube.

### SUMMARY OF THE INVENTION

Although the cable assembly described allows high currents to be transmitted, there are still limits to the maximum currents that can be transmitted. This is particularly evident in electric vehicles with increasingly powerful drives, such as trucks.

A particular problem is the electrical interconnection of the drive batteries to the charging socket or the drive motor, but also, in general, the interconnection between different connection boxes, where currents in excess of 1000 A can occur in an electric vehicle. Traditionally, copper conductors with a very large cross-section are used for this purpose. However, this is not satisfactory, on the one hand due to the high material costs and on the other hand due to the high weight of conductors with a large cross-section. In fact, such a cooled cable is 3-4 times lighter than a corresponding uncooled cable.

Cooled cables of the type mentioned above represent a potential solution in this application, as they are less expensive and weigh less than conventional cables due to the presence of a cooling device. However, the applicant has found that with such cooled cables, which are suitable for transmitting more than 1000 A, the connection of the cable with a transition from an uncooled to a cooled area is particularly critical. Specifically, preliminary tests have resulted in localized overheating of electrically conductive parts.

It is therefore an objective of the present invention to overcome the above-mentioned shortcomings in the prior art. In particular, it is an objective of the present invention to provide a cable assembly of the above-mentioned type which is suitable for the electrical interconnection of drive components in an electric vehicle. The cable assembly should be suitable for transmitting more than 1000 A, preferably more than 2000 A, and more preferably more than 3000 A. In addition, the cable assembly should be as inexpensive as possible to manufacture and have a low weight.

This objective is solved by a cable assembly with the features described herein. The cable assembly comprises a cable conduit which forms a continuous interstitial space along a longitudinal direction. A plurality of electrical conductors extend along the longitudinal direction within the interstitial space. The interstitial space is suitable for conducting a coolant. The cable assembly also comprises a first terminal element to which the electrical conductors are individually electrically interconnected at a first end of the cable conduit.

It has been shown that the use of a terminal element to which the electrical conductors are individually electrically interconnected at a first end of the cable conduit can significantly increase the maximum current that can be transmitted via the cable assembly. In particular, the terminal element allows a well-defined transition from a cooled cable section with a small overall cross-section to an uncooled cable section with a large overall cross-section.

Preferably, the local temperature of electrically conductive parts at any point of the cable assembly does not exceed 90° C., preferably 80° C., more preferably 70° C. or 60° C. In practice, it has been shown that for a 1.5 m long cable according to the invention with a total conductor cross-section of 150 mm² and a current of 1500 A, a flow rate of approx. 3 l/min of coolant is sufficient to cool the cable sufficiently with an approx. 3° C. increase in the temperature of the coolant.

The terminal element is preferably made of a material that is both a good electrical conductor and thermal conductor, for example copper.

The terminal element can be arranged outside the interstitial space. Although the terminal element is therefore not usually cooled, it has been shown that sufficient temperature control can still be achieved due to its larger electrical conductor cross-section.

The electrical conductors can be individually spaced interconnected electrically to the terminal element. Because the electrical conductors are interconnected separately to the terminal element, there is no need to join the conductors together. Therefore, the uncooled area of the conductors can be kept as short as possible. In addition, this allows the increase in conductor cross-section through the terminal element to be well defined, which would not be the case if the conductors were bundled, for example. If the conductors are separately exposed for a short distance, air cooling takes place in addition to heat dissipation via the terminal element.

The electrical conductors can be spaced in the lateral direction within the interstitial space, in particular by means of a plurality of spacers which are arranged offset in the longitudinal direction within the interstitial space. This measure also prevents local overheating of electrically conductive parts. The distance between the spacers in the longitudinal direction can be, for example, 20-50 cm, preferably 25-40 cm, for example 30 cm.

The spacers can be made of a plastic material, in particular by injection molding or 3D printing.

Alternatively, the plurality of spacers can be in the form of coil springs, arranged between the electrical conductors and extending in the longitudinal direction within the interstitial space. Such spacers are comparatively cost efficient and allow an equal spacing of the electrical conductors over the entire length of the cable. This is beneficial for a good cooling as the coil springs avoid that the electrical conductors come in direct contact with each other, which enables that the electrical conductors can be surrounded by coolant.

The electrical conductors can be helically stranded in the longitudinal direction of the cable conduit. Due to the helical structure of the electrical conductors the cable is flexible and causes turbulence in the coolant conducted through the cable conduit, which significantly improves heat transfer.

The number of electrical conductors can be 2 to 20, preferably 3 to 12, in particular 3, 4, 5, 6, 7, 8, 9, 10, 11, or 12. Such numbers of conductors offer an optimal compromise in terms of total conductor cross-section, cooling surface, space requirements, and installation effort.

In a preferred embodiment, all electrical conductors have the same cross-section. However, different cross-sections are also conceivable. Different cross-sections can be advantageous if this facilitates the arrangement in the available space and optimizes the compromise described above.

The terminal element may have an electrical conductor cross-section that is at least three times the sum of the cross-sections of the electrical conductors, preferably at least five times, and more preferably at least ten times. Practical experience has shown that such cross-sectional ratios are sufficient to prevent overheating of the uncooled areas when transitioning from a cooled cable section with a small total cross-section to an uncooled cable section with a large total cross-section.

The electrical conductors can be electrically connected to the terminal element via connection elements. The connection elements can each comprise a receptacle into which an electrical conductor is inserted each. The electrical conductors can be crimped with the connection elements. Alternatively, however, soldering, welding, or rotary swagging can also be used. This allows a low contact resistance to be achieved and simplifies assembly.

The connection elements may each comprise a conical section that engages with a corresponding bore in the terminal element. This allows a high contact pressure of the elements and thus a low contact resistance to be achieved. The connection elements may comprise a front bore with an internal thread so that they can be fastened to the terminal element using screws. This type of fastening has the advantage that tightening the screw creates preload and thus good contact. Alternatively, however, pressing, riveting, soldering, or welding may also be used.

As already mentioned, the electrical conductors and/or the connection elements may comprise a section in the longitudinal direction of the cable conduit that extends outside the interstitial space. The conductive sections of the electrical conductors and/or the connection elements that extend outside the interstitial space can correspond to a maximum of 10 times the diameter of the electrical conductor, preferably a maximum of 8 times the diameter, and preferably a maximum of 5 times the diameter. It has been shown that such section lengths of uncooled areas are tolerated without causing local overheating.

In a preferred embodiment, the terminal element can close off the interstitial space. In particular, the terminal element can protrude into the first end of the cable conduit. This has the advantage that the conductive sections of the electrical conductors and/or the connection elements extending outside the interstitial space can be completely avoided. In such a case, the electrical conductors do not comprise a jacket. Omitting the jacket further improves the heat transfer between the conductors and the coolant. However, an electrically insulating coolant must then be used.

The electrical conductors can be designed as strands, preferably made of copper. Strands have the particular advantage of high flexibility and low risk of breakage, which is especially important for flexible cables, but also for cables that are regularly exposed to movement or vibration.

The electrical conductors can each comprise a jacket, with a first end of each electrical conductor being free of the jacket. The jacket allows a non-insulating coolant to be used.

The cable conduit may comprise a sealing element at its first end, which seals the interstitial space. This design has proven to be particularly advantageous.

The sealing element may comprise a substantially cylindrical shape and seal the end of the cable conduit, in particular in the manner of a plug. The sealing element may comprise an inner side facing the interstitial space and an outer side facing away from the interstitial space.

The electrical conductors and/or connection elements can be routed through the sealing element, in particular through several passages in the sealing element, from the inner side to the outer side. This design provides a simple and reliable solution to the problem of coolant encapsulation.

The electrical conductors can extend into the sealing element on the inner side. The sealing element can form several sealing connections with the electrical conductors, and if necessary with their jackets. Especially when using strands, it is difficult to seal the actual electrical conductor, so that a sealing connection between the sealing element and the jacket is a preferred solution.

A sealing connection between the sealing element and the jacket also has the general advantage that the coolant does not come into direct contact with the electrical conductors. Accordingly, a coolant that is electrically conductive can also be used. In this context, a mixture of water and ethylene glycol is particularly preferred, as this is used as standard in the existing cooling circuit of a vehicle.

However, it goes without saying that the present invention is not limited to embodiments in which the electrical conductors do not come into contact with the coolant. Such embodiments are also conceivable, in which case electrically non-conductive cooling media, such as insulating oils, are preferably used. So-called insulating oils, also known as transformer oils, such as highly refined mineral oil or a low-viscosity silicone oil, are particularly suitable for this purpose.

The electrical conductors can be interconnected with the connection elements within the sealing element.

The connection elements can extend beyond the outer side of the sealing element. This allows the terminal element to be easily connected.

The sealing element can be in the form of a sleeve which extends along the longitudinal direction and at least partially circumferential to the plurality of electrical conductors. The sleeve may comprise at a first end a partition wall, with the inner side facing the interstitial space and the outer side facing away from the interstitial space and preferably being arranged adjacent to the terminal element.

The sealing element may comprise additional sealing means, e.g., O-rings which establish a sealing connection between the sealing element and the jacket to prevent that coolant leaks from the interstitial space.

The sealing element typically terminates the interstitial space and separates the coolant from the terminal element. The sealing element may comprise an outlet which routes the coolant out from the interstitial space in such a way that the uncooled section is kept as short as possible before its cross-section increases significantly. This design enables quick and detachable integration of a cable with other components of the system, ensuring both ease of assembly and fluid containment.

In an alternative embodiment, the sealing element may be arranged circumferential to the terminal element, in particular as a sealing ring in the form of a hollow cylinder. This is particularly advantageous if the terminal element closes the interstitial space (see above). In order to achieve a sufficient sealing connection between the terminal element and the connection elements, it is advantageous in such a case to arrange additional sealing means, e.g., O-rings, on the connection elements. An outer contour of the sealing element and/or the passages may comprise protrusions and/or indentations which interact with the electrical conductors and/or the connection elements and/or the cable conduit to seal the interstitial space.

The sealing element may be made of an elastically deformable material, in particular silicone.

The cable assembly may comprise an inlet for feeding the coolant into the interstitial space. The inlet may extend into the interstitial space and comprise a nozzle for vortexing of the inflowing coolant. This allows an optimized heat transfer to be achieved. Local overheating of electrically conductive areas is avoided.

The cable assembly may comprise at least one outlet for discharging the coolant from the interstitial space. The outlet may extend within the interstitial space along the at least one electrical conductor. This makes it possible, depending on the design and requirements, for the coolant to be conducted either from the first end of the cable conduit to a second end. Alternatively, however, the coolant may also enter and exit at the first end of the cable conduit.

Preferably, both the inlet of the coolant into the interstitial space and its outlet take place through the sealing element.

The terminal element can be designed as a terminal plate or as a cable shoe. In particular, the terminal element can be designed as an L-shaped cable shoe, which comprises a section that extends along the longitudinal direction of the cable conduit. This is a common form of cable shoe, which can be easily fixed to a busbar and contacted by means of a screw.

Alternatively, the terminal element can be designed as part of an electric plug, which may comprise at least one elastic contact element along the longitudinal direction of the plug. The elastic contact element is typically foreseen to establish an electrical connection with a mating plug or socket. The plug may be a male plug, which comprises circumferentially arranged clastic contact elements in the form of coil springs. These springs can enable a reliable electrical connection even under changing loads or vibrations. Alternatively, the plug may be a female plug with at least one elastic contact element being arranged circumferentially or being arranged on a mating male plug.

The cable conduit can be designed as a corrugated tube. Preferably, the scaling element arranged therein can be secured against longitudinal displacement by means of a retaining element. The retaining element can be designed as a clamp which comprises a stop for the scaling element.

Alternatively, the cable conduit can be in the form of a dual-layer extruded tube, separated by a shielding layer. This structure isolates both the cable conduit and the coolant from the external environment while maintaining flexibility. The insulation ensures safe operation and mechanical integrity (including tightness) under varying thermal and mechanical conditions.

The cable conduit may be at least partially encompassed by a braid to shield the electromagnetic radiation of the electrical conductors.

The cable assembly may also comprise a cable gland.

The cable gland can comprise a first sleeve and a second sleeve extending along the longitudinal direction at least partially circumferential with respect to each other. The first and the second sleeve are typically configured to receive the first end of the cable conduit between the first sleeve and the second sleeve. The first end of the cable conduit may be clamped, preferably crimped, between the first and the second sleeve.

The cable gland may comprise a third sleeve extending along the longitudinal direction at least partially circumferential with respect to the first sleeve and the second sleeve and the sealing element. The third sleeve may comprise along the longitudinal direction a first end and an opposite second end, with the first end comprising a flange for securing the second sleeve and the sealing element with respect to the first terminal element along the longitudinal direction. The second sleeve may comprise a collar, extending at least partially circumferentially away from the second sleeve. The flange of the third sleeve may interact with and secure the collar of the second sleeve with respect to the sealing element, thereby securing the cable conduit and the therein arranged electrical conductors and optionally the sealing element along the longitudinal direction.

The cable assembly may comprise a flange for attaching the cable assembly to an external component. The flange may have a center opening through which the terminal element extends. The cable assembly can comprise a voltage protection means being arranged circumferentially with respect to the first terminal element. The voltage protection means may abut against the sealing element and may be secured along the longitudinal direction by the flange.

Alternatively or in addition, the mating plug or socket may comprise a voltage protection means, configured to work as a finger protection meeting the requirements of ISO 20653-2023. The voltage protection means of the mating plug or socket can be spring-loaded and movable along the longitudinal direction. A central element of the voltage protection means may be designed to move backward, revealing the conductive components when the connector is inserted into the socket or vice versa. A spring can ensure the voltage protection means to return as the connection is disconnected.

The cable assembly may also comprise a second terminal element to which the electrical conductors are electrically connected at a second end of the cable conduit.

The present invention also relates to a vehicle, in particular selected from a group of land vehicles, preferably passenger cars, trucks, and agricultural machines, air craft, preferably airplanes and helicopters, watercraft, preferably boats, submarines, and ships, and spacecraft, comprising a cable assembly as described above.

However, it goes without saying that the present invention is not limited to use in vehicles. It also relates to stationary equipment, in particular selected from a group of infrastructure facilities, robots, and charging stations, comprising a cable assembly as described above.

### BRIEF DESCRIPTION OF THE DRAWINGS

Aspects of the disclosure are explained in more detail on the basis of the embodiments shown in the following figures and the accompanying description.

FIG. 1 shows a perspective partial sectional view of a first embodiment of a cable assembly according to the present invention;

FIG. 2 shows a partial enlargement of the representation according to FIG. 1;

FIG. 3 shows an exploded view of the embodiment according to FIG. 1;

FIG. 4 shows a partial enlargement of the representation according to FIG. 3;

FIG. 5 shows a perspective partial sectional view of a second embodiment of a cable assembly according to the present invention;

FIG. 6 shows a partial enlargement of the representation according to FIG. 5;

FIG. 7 shows a perspective partial sectional view of a third embodiment of a cable assembly according to the present invention;

FIG. 8 shows a partial enlargement of the representation according to FIG. 7;

FIG. 9 shows a perspective partial sectional view of a fourth embodiment of a cable assembly according to the present invention;

FIG. 10 shows an exploded view of the embodiment according to FIG. 9;

FIG. 11 shows a perspective partial sectional view of a fifth embodiment of a cable assembly according to the present invention;

FIG. 12 shows an exploded view of the embodiment according to FIG. 11;

FIG. 13 shows a perspective partial sectional view of a sixth embodiment of a cable assembly according to the present invention;

FIG. 14 shows a partial enlargement of the representation according to FIG. 13; and

FIG. 15 shows a perspective partial exploded sectional view of the representation according to FIG. 13.

### DESCRIPTION OF THE EMBODIMENTS

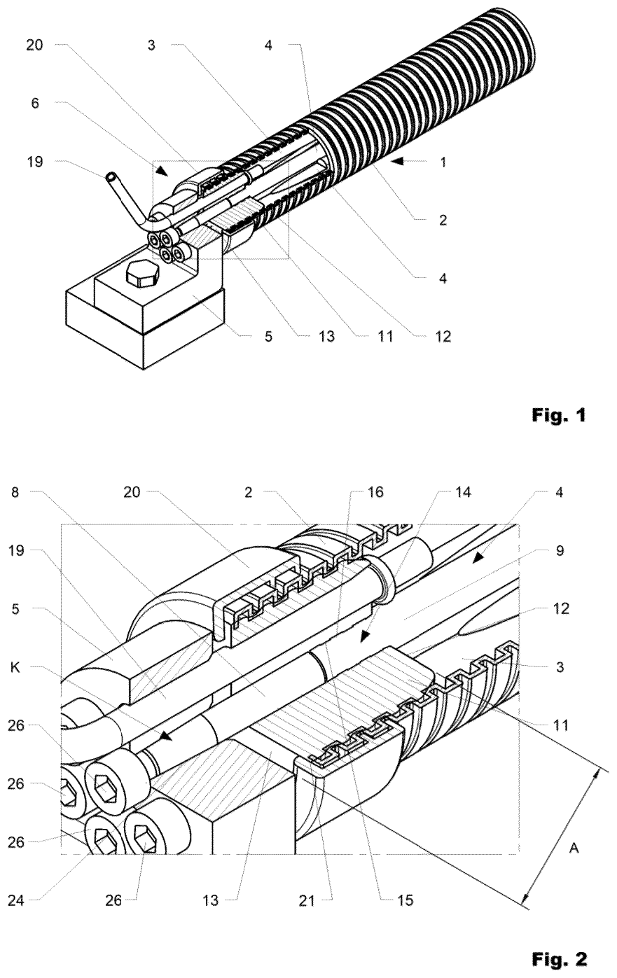

FIG. 1 shows a first embodiment of a cable assembly 1 according to the present invention. The cable assembly 1 comprises a cable conduit 2, which is designed as a corrugated tube. The cable conduit 2 forms an interstitial space 3 that is continuous in the longitudinal direction and is closed at a first end 6 of the cable conduit 2 by a sealing element 11. A total of six electrical conductors 4 run in the longitudinal direction within the interstitial space 3. The conductors 4 are guided through the sealing element 11 and interconnected individually and in the lateral direction to a terminal element 5 on an outer side 13 of the sealing element 11. The sealing element 11 comprises several passages 14 (see FIG. 2). A coolant can be conducted through the interstitial space 3, which can be discharged via an outlet 19 (supply line not shown). The outlet 19 is guided through the terminal element 5 and also through the sealing element 11. The terminal element 5 is designed as an L-shaped cable shoe. The coolant outlet is located at an opposite second end of the cable assembly 1 (not shown). In the example shown, the conductive sections A of the electrical conductors 4 and the connection elements 8, which extend outside the interstitial space 3, correspond to approximately four times their diameter.

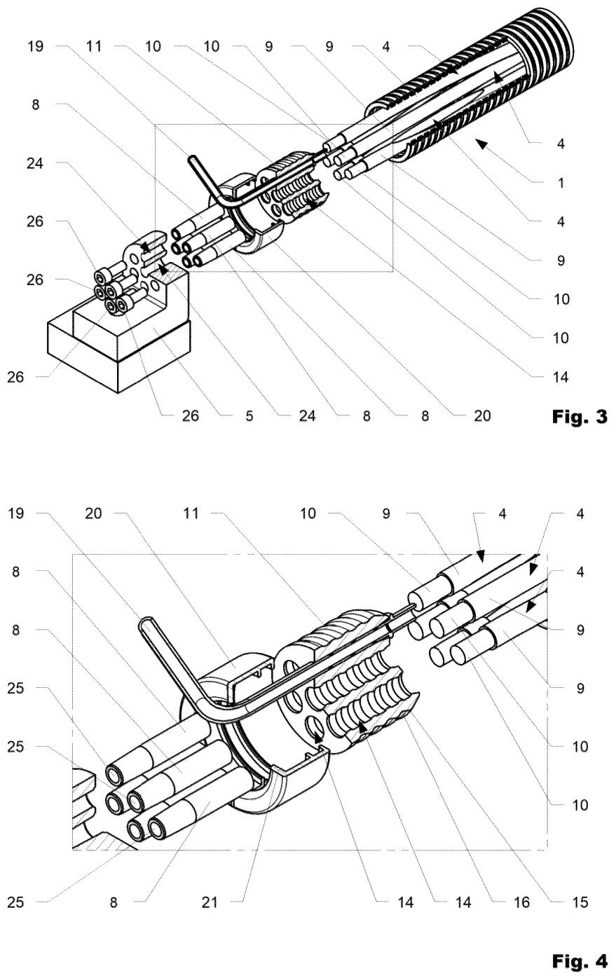

FIGS. 2 to 4 show further details of the cable assembly 1 according to FIG. 1. It can be seen that the electrical conductors 4 are interconnected with the terminal element 5 via connection elements 8. The connection elements 8 each comprise a receptacle (not visible) into which a first end 10 (see FIG. 3) of an electrical conductor 4 engages. The electrical conductors 4 are crimped with the connection elements 8. The connection elements 8 also each comprise a conical section K, with which they engage in a corresponding bore 24 of the terminal element 5. The connection elements 8 also each comprise a front bore 25 (see FIG. 4) with an internal thread for fastening to the terminal element 5 by means of a screw 26.

The cable conduit 2 is sealed at its first end 6 by the sealing element 11. The sealing element 11 comprises a substantially cylindrical shape for this purpose and seals the cable conduit 2 in the manner of a plug. An outer contour of the sealing element 11 and the passages 14 comprise protrusions 15 and indentations 16, which interact with the electrical conductors 4, the connection elements 8, and the cable conduit 2 to seal the interstitial space 3. The sealing element 11 arranged in the cable conduit 2 is secured against displacement in the longitudinal direction by means of a retaining element 20. The retaining element 20 is designed as a clamp which comprises a stop 21 for the scaling element 11.

The electrical conductors 4 extend into the sealing element 11 on the inner side 12 thereof. Inside the sealing element 11, the electrical conductors are interconnected with the connection elements 8. The connection elements 8 extend out of the sealing element 11 on the outer side 13 thereof.

The electrical conductors 4 each comprise a jacket 9. The sealing element 11 forms several sealing connections with the jackets 9. The electrical conductors 4 therefore do not come into direct contact with the coolant. As mentioned above, this allows the use of an electrically conductive coolant, for example a mixture of water and ethylene glycol.

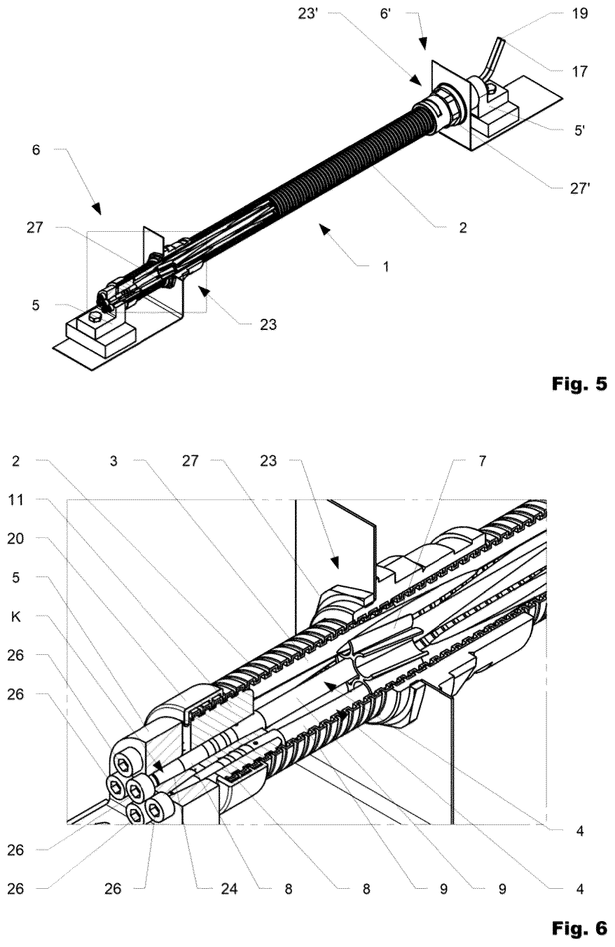

FIGS. 5 and 6 show a second embodiment of a cable assembly 1 according to the invention. In contrast to the example shown in FIGS. 1 to 4, in this embodiment both the inlet 17 and the outlet 19 for the coolant are located at the same end of the cable assembly 1, namely at the second end 6′. The outlet 19 extends within the interstitial space 3 along the electrical conductors 4 from the first end 6 to the second end 6′. FIG. 6 also shows a spacer 7 which keeps the electrical conductors 4 spaced apart in the lateral direction within the interstitial space 3. The electrical conductors 4 are helically stranded in the longitudinal direction of the cable conduit 2. The cable assembly 1, namely the cable conduit 2, is screwed to a cable bushing 27 at both its first end 6 and its second end 6′ by means of a cable gland 23.

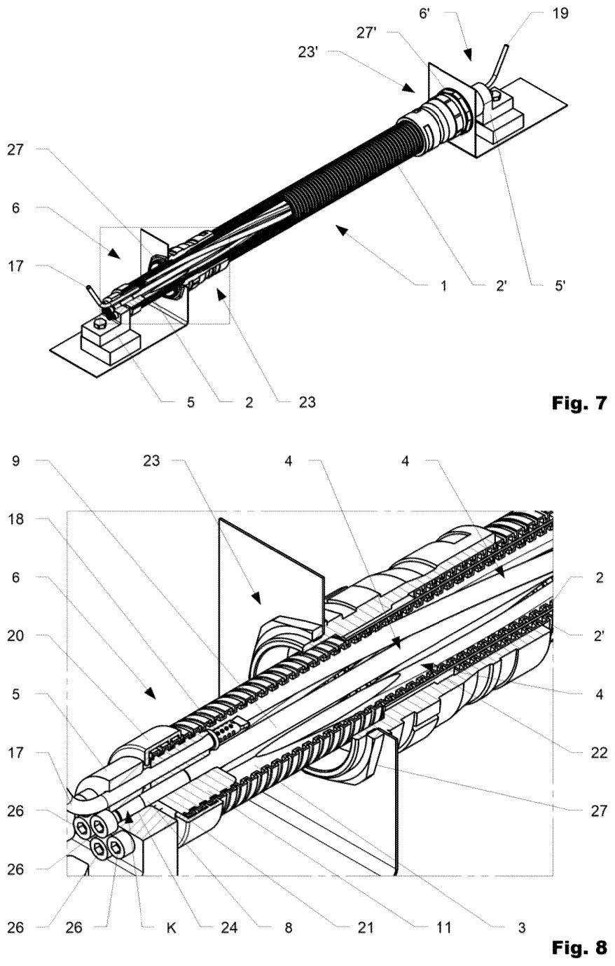

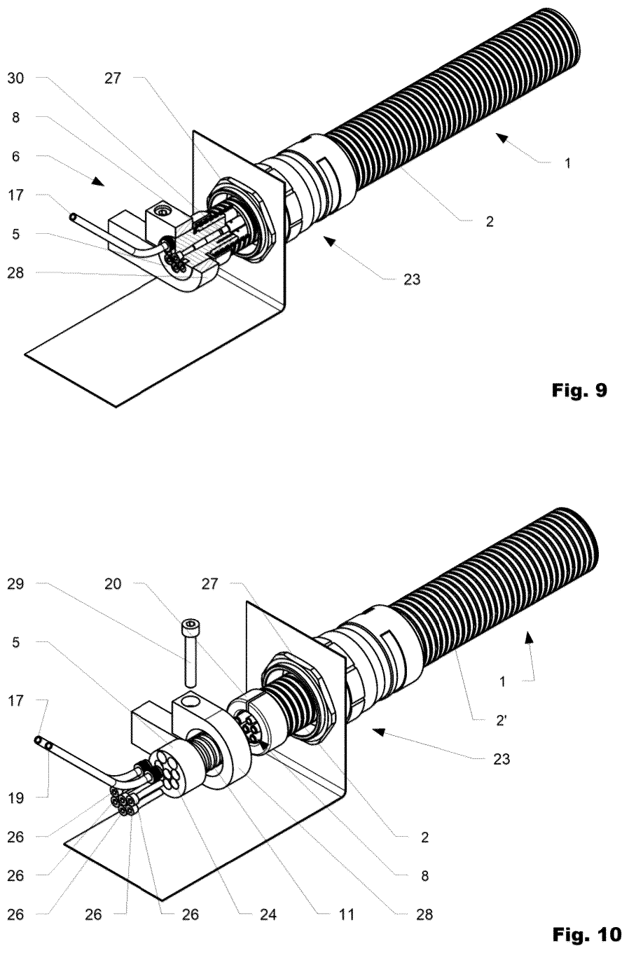

FIGS. 7 and 8 show a third embodiment of a cable assembly 1 according to the invention. In contrast to the example shown in FIGS. 5 and 6, this cable assembly 1 comprises a second outer cable conduit 2′ in addition to the first inner cable conduit 2, both of which are designed as corrugated tubes. The outer cable conduit 2′ is screwed to the cable bushings 27, 27′ by means of cable glands 23, 23′. A braid 22 is arranged between the two cable conduits 2 and 2′ to shield electromagnetic radiation from the electrical conductors 4. The inlet 17 extends into the interstitial space 3 and comprises a nozzle 18 for vortexing the inflowing coolant.

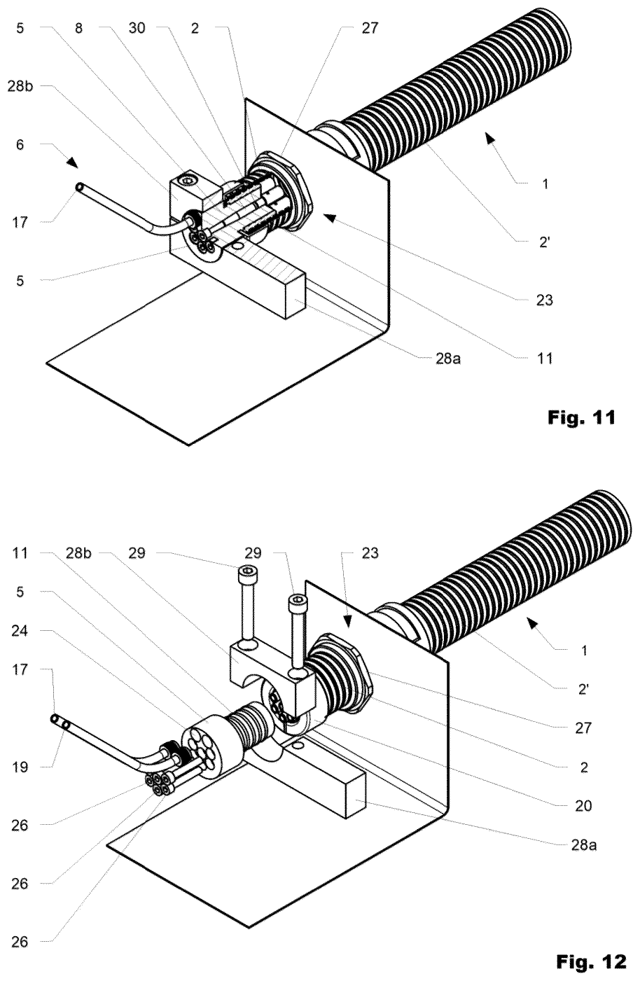

FIGS. 9 and 10 show a fourth embodiment of a cable assembly 1 according to the invention. In this example, the terminal element 5 is designed as a terminal plate. The terminal element 5 is contacted by means of a lug 28. The lug 28 is designed as a single piece and is tightened by a screw 29. Furthermore, this embodiment is characterized in that the terminal element 5 protrudes into the cable conduit 2. The sealing element is arranged as a scaling ring in the form of a hollow cylinder around the terminal element 5, i.e., between the terminal element 5 and the cable conduit 2. In order to achieve a sufficient sealing connection between the terminal element 5 and the connection elements 8, an O-ring 30 is arranged on each of the connection elements 8. In this embodiment, unshielded electrical conductors (not visible) are used.

FIGS. 11 and 12 show a fifth embodiment of a cable assembly 1 according to the present invention. This essentially corresponds to the example shown in FIGS. 9 and 10. However, the lug is two-pieced, i.e., it comprises two halves 28a and 28b and is tightened to the terminal element 5 by means of two screws 29.

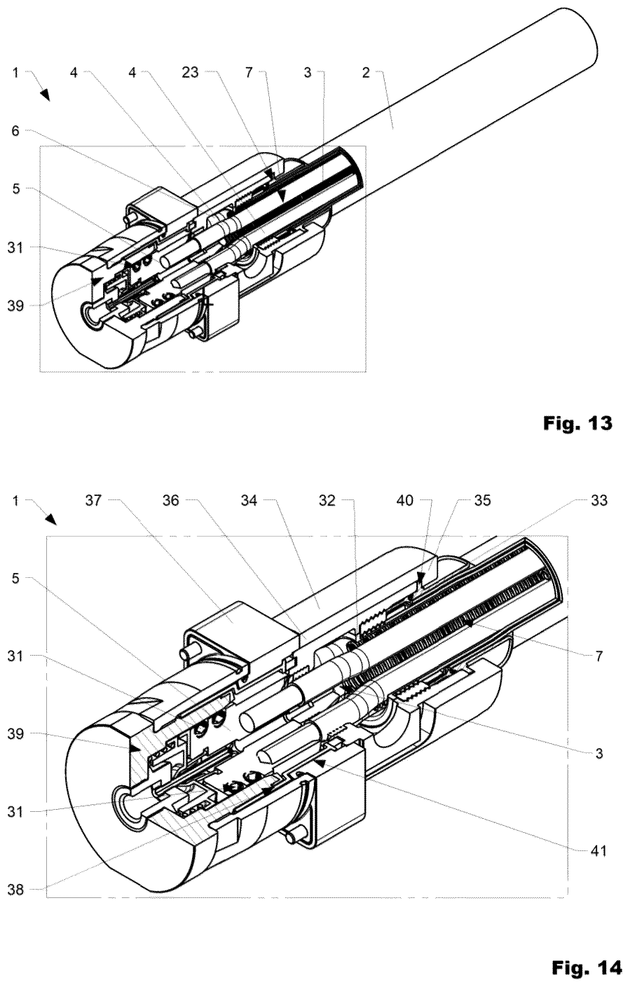

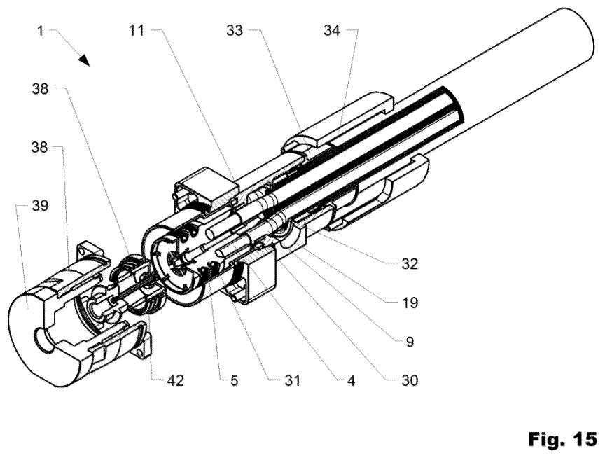

FIGS. 13 to 15 show a sixth embodiment of a cable assembly 1 according to the invention. This embodiment comprises a terminal element 5 designed as a male plug, which comprises elastic contact elements 31 along the longitudinal direction. The elastic contact element 31 is foreseen to establish an electrical connection with the mating female plug 39. The shown male plug comprises circumferentially arranged elastic contact elements 31 in the form of coil springs for establishing a reliable electrical connection with the mating plug.

The shown cable assembly 1 comprises a sealing element in the form of a sleeve which extends along the longitudinal direction and at least partially circumferential to the plurality of electrical conductors. The sleeve comprises at a first end a partition wall, with the inner side facing the interstitial space and the outer side facing away from the interstitial space and preferably being arranged adjacent to the terminal element.

The shown sealing element 11 comprises additional sealing means in the form of O-rings 30, which establish a sealing connection between the sealing element 11 and the jacket 9 to prevent that coolant leaks from the interstitial space 3.

The shown sealing element 11 terminates the interstitial space 3 and separates the coolant from the terminal element 5. The sealing element 11 comprises an outlet 19 which routes the coolant out from the interstitial space 3 in such a way that the uncooled section is kept as short as possible before its cross-section increases significantly. This design enables quick and detachable integration of a cable with other components of the system, ensuring both case of assembly and fluid containment.

The shown cable conduit 2 comprises a plurality of electrical conductors 4 and a plurality of spacers 7 in the form of coil springs, arranged between the electrical conductors 4 and extending in the longitudinal direction within the interstitial space 3. For attaching the cable conduit to an external component in a strain relieved manner, the cable assembly 1 comprises a cable gland 23. The shown cable gland 23 comprises a first sleeve 32 and a second sleeve 33 extending along the longitudinal direction at least partially circumferential with respect to each other. The first 32 and the second 33 sleeve are configured to receive the first end 6 of the cable conduit 2 between each other. The first end 6 of the cable conduit 2 is crimped between the first 32 and the second sleeve 33. The cable gland 23 further comprises a third sleeve 34 extending along the longitudinal direction at least partially circumferential with respect to the first sleeve 32 and the second sleeve 33 and the sealing element 11.

The third sleeve 34 comprises along the longitudinal direction a first end 35 and an opposite second end 36, with the first end 35 comprising a flange for securing the second sleeve 33 and the sealing element 11 with respect to the first terminal element 5 along the longitudinal direction and the second end abutting against a flange 37. The second sleeve 33 comprises a collar 40, extending at least partially circumferentially away from the second sleeve 33. The flange of the third sleeve 34 secures the collar 40 of the second sleeve 32 with respect to the sealing element 11, thereby securing the cable conduit 2 and the therein arranged electrical conductors 4 along the longitudinal direction.

The shown flange 37 is foreseen for attaching the cable assembly 1 to an external component. The flange 37 comprises a center opening 41 through which the terminal element 5 extends. The cable assembly 1 also comprises a voltage protection means 38, being arranged circumferentially with respect to the first terminal element 5. The voltage protection means 38 abuts against the sealing element 11 and is secured along the longitudinal direction by the flange 37.

The mating plug 39 in the form of a socket also comprises a voltage protection means 38, configured to work as a finger protection. The voltage protection means 38 of the socket is spring-loaded and movable along the longitudinal direction. A central element of the voltage protection means 38 is designed to move backward, revealing the conductive components when the connector is inserted into the socket. The spring 42 ensure the voltage protection means 38 to return as the connection is disconnected.

### Example

Cable assembly according to FIGS. 7 and 8 with the following configuration:
Length: 1.5 m
Total cross-section: 150 mm² (6×25 mm², insulated, 1 strand)
Corrugated tube outer: 42.4 mm
Corrugated tube inner: 35.7 mm
Coolant lines: 6.0 mm (inner diameter)/8.0 mm (outer diameter)
Terminal elements Copper cable shoe
(20×40 mm; hole 10 mm)
Braid: Yes
Spacer: Yes

### Features:

Weight when empty: 4.8 kg
Weight filled: 5.9 kg
   Min. bending radius: 140 mm

### Test Series:

| | 1 | | 2 | | 3 | |
|---|---|---|---|---|---|---|
| Cooling water | 25.0° | C. | 25.0° | C. | 25.0° | C. |
| temperature, feed | | | | | | |
| Cooling water | 26.2° | C. | 27.2° | C. | 27.7° | C. |
| temperature return | | | | | | |
| Flow rate | 2.95 | l/min | 2.95 | l/min | 2.95 | l/min |
| Cross-section of | 2 × 400 | mm² | 2 × 400 | mm² | 2 × 400 | mm² |
| connection cable | | | | | | |
| Current | 1,500 | A | 2,000 | A | 2,200 | A |
| Temperature at cable | 46° | C. | 71° | C. | 82° | C. |
| shoes | | | | | | |
| Temperature at | 45° | C. | 72° | C. | 83° | C. |
| connection cables | | | | | | |

1. A cable assembly comprising a cable conduit which forms a continuous interstitial space along a longitudinal direction, wherein a plurality of electrical conductors extend along the longitudinal direction within the interstitial space, wherein the interstitial space is suitable for conducting a coolant, wherein the cable assembly further comprises a first terminal element with which the electrical conductors are individually electrically interconnected at a first end of the cable conduit.

2. The cable assembly according to claim 1, wherein the terminal element is arranged outside the interstitial space.

3. The cable assembly according to claim 1, wherein the electrical conductors are individually spaced apart and electrically interconnected to the terminal element.

4. The cable assembly according to claim 1, wherein the electrical conductors are spaced apart in the lateral direction within the interstitial space.

5. The cable assembly according to claim 4, wherein the electrical conductors are helically stranded in the longitudinal direction of the cable conduit.

6. The cable assembly according to claim 1, wherein the number of electrical conductors is one selected from the group consisting of the following: 2 to 20, 3 to 12 and 3, 4, 5, 6, 7, 8, 9, 10, 11, or 12.

7. The cable assembly according to claim 1, wherein the terminal element comprises an electrical conductor cross-section which corresponds to one selected from the group consisting of the following: at least three times the sum of the cross-sections of the electrical conductors, at least five times and at least ten times.

8. The cable assembly according to claim 1, wherein the electrical conductors are electrically interconnected to the terminal element via connection elements.

9. The cable assembly according to claim 1, wherein at least one out of the electrical conductors and the connection elements comprise a section in the longitudinal direction of the cable conduit which extends outside the interstitial space.

10. The cable assembly according to claim 9, wherein at least one selected from the group consisting of the conductive sections of the electrical conductors and the connection elements extending outside the interstitial space correspond to one out of the following: a maximum of 10 times the diameter of the electrical conductors, a maximum of 8 times the diameter and a maximum of 5 times the diameter.

11. The cable assembly according to claim 1, wherein the electrical conductors are designed as strands.

12. The cable assembly according to claim 1, wherein the electrical conductors each comprise a jacket, wherein a respective first end of the electrical conductors is free of the jacket.

13. The cable assembly according to claim 1, wherein the cable conduit comprises a sealing element at its first end, which seals the interstitial space.

14. The cable assembly according to claim 13, wherein the sealing element comprises an inner side facing the interstitial space and an outer side facing away from the interstitial space.

15. The cable assembly according to claim 13, wherein at least one selected from the group consisting of the electrical conductors and the connection elements are guided through the sealing element from the inner side to the outer side.

16. The cable assembly according to claim 1, comprising an inlet for guiding the coolant into the interstitial space.

17. The cable assembly according to claim 16, wherein the inlet extends into the interstitial space and comprises a nozzle for vortexing the inflowing coolant.

18. The cable assembly according to claim 1, comprising at least one outlet for discharging the coolant from the interstitial space.

19. The cable assembly according to claim 18, wherein the outlet extends within the interstitial space along the electrical conductors.

20. The cable assembly according to claim 1, wherein the terminal element is designed as a terminal plate or cable shoe.

21. The cable assembly according to claim 1, wherein the terminal element is designed as part of an electric plug, which comprises at least one elastic contact element along the longitudinal direction of the plug.

22. The cable assembly according to claim 1, wherein the cable assembly comprises a second terminal element with which the electrical conductors are electrically interconnected at a second end of the cable conduit.

23. A vehicle, in particular selected from a group of land vehicles, preferably passenger cars, trucks, and agricultural machines, aircraft, preferably airplanes and helicopters, watercraft, preferably boats, submarines, and ships, and spacecraft, comprising a cable assembly according to claim 1.

24. A stationary device, in particular selected from a group of infrastructure facilities, robots, and charging stations, comprising a cable assembly according to claim 1.
